(19) United States
(12) Patent Application Publication
(10) Pub. No.: US 2017/0123775 A1
(43) Pub. Date: May 4, 2017

(54) COMPILATION OF APPLICATION INTO MULTIPLE INSTRUCTION SETS FOR A HETEROGENEOUS PROCESSOR

(71) Applicant: EMPIRE TECHNOLOGY DEVELOPMENT LLC, Wilmington, DE (US)

(72) Inventors: Shijie XU, Beijing (CN); Qi GUO, Beijing (CN); Qi LI, Beijing (CN); Xuefeng SONG, Shijiazhuang (CN)

(73) Assignee: EMPIRE TECHNOLOGY DEVELOPMENT LLC, Wilmington, DE (US)

(21) Appl. No.: 15/128,427

(22) PCT Filed: Mar. 26, 2014
(86) PCT No.: PCT/CN2014/074114

§ 371 Date: Sep. 23, 2016

(51) Int. Cl. G06F 9/45

(52) U.S. Cl. CPC G06F 8/451

(57) ABSTRACT

Techniques generally described are related to a method to compile code for a heterogeneous multi-core processor that includes a first core and a second core. The method may include receiving, by a multi-core compilation system, a set of source code that includes a plurality of code segments, wherein the multi-core compilation system is configured to compile the set of source code and generate an executable program that is executable by the heterogeneous multi-core processor. The method may include generating, by the multi-core compilation system, a first instruction set based on a specific code segment selected from the plurality of code segments, wherein the first instruction set is executable by the first core of the heterogeneous multi-core processor. The method may further include, in response to a determination that a performance indicator associated with the first core executing the first instruction set is above a particular threshold, generating, by the multi-core compilation system, a second instruction set based on the specific code segment, wherein the second instruction set is executable by the second core of the heterogeneous multi-core processor, and the first instruction set and the second instruction set are implemented in the executable program.

### BACKGROUND

Unless otherwise indicated herein, the materials described in this section are not prior art to the claims in this application and are not admitted to be prior art by inclusion in this section.

A heterogeneous multi-core processor that supports a heterogeneous Instruction Set Architecture (heterogeneous ISA, H-ISA) may provide better performance and achieve higher efficiency in power consumption than a conventional multi-core processor. Conventional applications are often compiled into instruction sets for a specific ISA, and during run time, can only utilize one core of the heterogeneous multi-core processor that corresponds to the specific ISA. When executing the conventional applications, one core of the heterogeneous multi-core processor may experience high power consumption, heavy load, and/or rising temperature, while the other cores of the heterogeneous multi-core processor associated with different ISAs may be idle or in a state of low load. As a result, the performance of the heterogeneous multi-core processor may be greatly affected. Further, as the number of cores integrated into a heterogeneous multi-core processor increases, the problems concerning the performance of the heterogeneous multi-core processor may become more and more prominent.

### SUMMARY

In accordance with some embodiments of the present disclosure, a method to compile code for a heterogeneous multi-core processor that includes a first core and a second core is disclosed. The method includes receiving, by a multi-core compilation system, a set of source code that includes a plurality of code segments, wherein the multi-core compilation system is configured to compile the set of source code and generate an executable program that is executable by the heterogeneous multi-core processor. The method may include generating, by the multi-core compilation system, a first instruction set based on a specific code segment selected from the plurality of code segments, wherein the first instruction set is executable by the first core of the heterogeneous multi-core processor. The method may further include, in response to a determination that a performance indicator associated with the first core executing the first instruction set is above a particular threshold, generating, by the multi-core compilation system, a second instruction set based on the specific code segment, wherein the second instruction set is executable by the second core of the heterogeneous multi-core processor, and the first instruction set and the second instruction set are implemented in the executable program.

In accordance with other embodiments of the present disclosure, another method to compile code for a heterogeneous multi-core processor that includes a first core and a second core is disclosed. The method may include receiving, by a multi-core compilation system, a set of source code that includes a plurality of code segments, wherein the multi-core compilation system is configured to compile the set of source code into an executable program that is executable by the heterogeneous multi-core processor. The method may include generating, by the multi-core compilation system based on the plurality of code segments, a first plurality of instruction sets that are executable by the first core of the heterogeneous multi-core processor; and generating, by the multi-core compilation system based on the plurality of code segments, a second plurality of instruction sets that are executable by the second core of the heterogeneous multi-core processor. The method may further include, for a first code segment selected from the plurality of code segments and associated with a first instruction set of the first plurality of instruction sets and a second instruct set of the second plurality of instruction sets, determining, by the multi-core compilation system, a first performance indicator associated with the first core executing the first instruction set and a second performance indicator associated with the second core executing the second instruction set; and in response to a determination that the first performance indicator is above the second performance indicator, selecting, by the multi-core compilation system, the second instruction set to implement the first code segment in the executable program.

In accordance with further embodiments of the present disclosure, a multi-core compilation system to compile code for a heterogeneous multi-core processor that includes a first core and a second core is disclosed. The multi-core compilation system may include a compiler module configured to receive a set of source code that includes a plurality of code segments, generate a first instruction set for a first code segment selected from the plurality of code segments, wherein the first instruction set is executable by the first core, and generate a second instruction set for the first code segment, wherein the second instruction set is executable by the second core. The multi-core compilation system may further include a code optimization module coupled with the compiler module, wherein the code optimization module is configured to link the first instruction set and the second instruction set into an executable program that is executable by the heterogeneous multi-core processor.

In accordance with additional embodiments of the present disclosure, a non-transitory computer-readable storage medium may have a set of computer-readable instructions stored thereon which, when executed by a processor, cause the processor to perform a method to compile code for a heterogeneous multi-core processor that includes a first core and a second core. The method may include receiving, by a multi-core compilation system, a set of source code that includes a plurality of code segments, wherein the multi-core compilation system is configured to compile the set of source code and generate an executable program that is executable by the heterogeneous multi-core processor. The method may include generating, by the multi-core compilation system, a first instruction set based on a specific code segment selected from the plurality of code segments, wherein the first instruction set is executable by the first core of the heterogeneous multi-core processor. The method may further include, in response to a determination that a performance indicator associated with the first core executing the first instruction set is above a particular threshold, generating, by the multi-core compilation system, a second instruction set based on the specific code segment, wherein the second instruction set is executable by the second core of the heterogeneous multi-core processor, and the first instruction set and the second instruction set are implemented in the executable program.

In accordance with additional embodiments of the present disclosure, a non-transitory computer-readable storage medium may have a set of computer-readable instructions stored thereon which, when executed by a processor, cause the processor to perform a method to compile code for a heterogeneous multi-core processor that includes a first core and a second core. The method may include receiving, by a multi-core compilation system, a set of source code that includes a plurality of code segments, wherein the multi-core compilation system is configured to compile the set of source code into an executable program that is executable by the heterogeneous multi-core processor. The method may include generating, by the multi-core compilation system based on the plurality of code segments, a first plurality of instruction sets that are executable by the first core of the heterogeneous multi-core processor; and generating, by the multi-core compilation system based on the plurality of code segments, a second plurality of instruction sets that are executable by the second core of the heterogeneous multi-core processor. The method may further include, for a first code segment selected from the plurality of code segments and associated with a first instruction set of the first plurality of instruction sets and a second instruct set of the second plurality of instruction sets, determining, by the multi-core compilation system, a first performance indicator associated with the first core executing the first instruction set and a second performance indicator associated with the second core executing the second instruction set; and in response to a determination that the first performance indicator is above the second performance indicator, selecting, by the multi-core compilation system, the second instruction set to implement the first code segment in the executable program.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 shows a block diagram of an embodiment of a multi-core compilation system for a heterogeneous multi-core processor;

FIG. 2 shows illustrative embodiments of executable programs that may be optimized or otherwise tailored when executed by a heterogeneous multi-core processor;

FIG. 3 shows a flow diagram of an illustrative embodiment of a process to compile multiple versions of instruction sets that may be used in connection with a heterogeneous multi-core processor during run time;

FIG. 4 shows a flow diagram of an illustrative embodiment of a process to compile multiple versions of instruction sets for a heterogeneous multi-core processor during compilation time;

FIG. 5 shows an illustrative embodiment of an example computer program product; and

FIG. 6 shows a block diagram of an illustrative embodiment of an example computer system,

all arranged in accordance to at least some embodiments of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. The aspects of the present disclosure, as generally described herein, and illustrated in the Figures, can be arranged, substituted, combined, and designed in a wide variety of different configurations, all of which are explicitly contemplated herein.

This disclosure is drawn, inter alia, to methods, apparatuses, computer programs, and systems related to the compilation of an application into multiple versions of instruction sets for a heterogeneous multi-core processor. Briefly stated, Techniques generally described are related to a method to compile code for a heterogeneous multi-core processor that includes a first core and a second core. The method may include receiving, by a multi-core compilation system, a set of source code that includes a plurality of code segments, wherein the multi-core compilation system is configured to compile the set of source code and generate an executable program that is executable by the heterogeneous multi-core processor. The method may include generating, by the multi-core compilation system, a first instruction set based on a specific code segment selected from the plurality of code segments, wherein the first instruction set is executable by the first core of the heterogeneous multi-core processor. The method may further include, in response to a determination that a performance indicator associated with the first core executing the first instruction set is above a particular threshold, generating, by the multi-core compilation system, a second instruction set based on the specific code segment, wherein the second instruction set is executable by the second core of the heterogeneous multi-core processor, and the first instruction set and the second instruction set are implemented in the executable program.

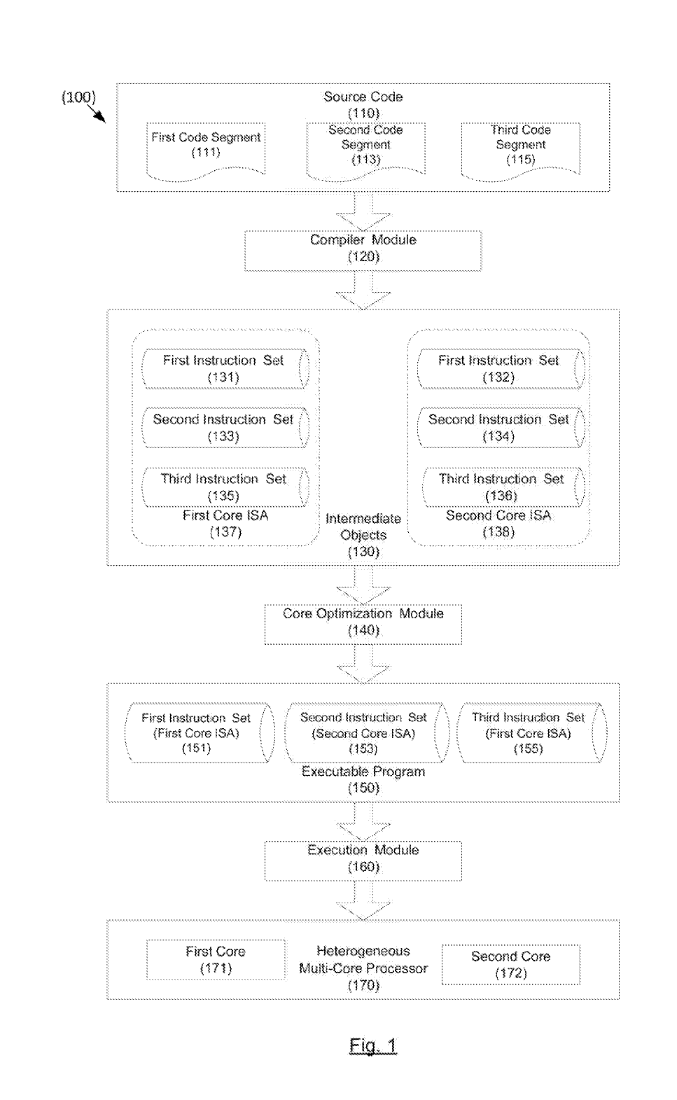

FIG. 1 shows a block diagram of an embodiment of a multi-core compilation system for a heterogeneous multi-core processor. In FIG. 1, a multi-core compilation system 100 to compile a set of source code 110 into an executable program 150 may include, among other components/modules, a compiler module 120 and a core optimization module 140. The compiler module 120 may be configured to compile the set of source code 110 into one or more versions of intermediate objects 130. The compiler module 120 may be coupled with the code optimization module 140, which may be configured to link one or more instruction sets in the multiple versions of intermediate objects 130 and generate the executable program 150 that can take advantage of or otherwise make use of the heterogeneous multi-core processor 170. The multi-core compilation system 100 may optionally include an execution module 160, which may be coupled with the compiler module 120 and/or the code optimization module 140, and may be configured to utilize the heterogeneous multi-core processor 170 to execute the executable program 150. The compiler module 120, the core optimization module 140, and/or the execution module 160 may include hardware modules, software modules, and/or hardware/software modules implemented in a computer system that includes the multi-core compilation system 100. For example, the compiler module 120 may include a C or Java® compiler installed in an operating system of the computer system. The core optimization module 140 may be a module that is running in the operating system and interacting with the compiler module 120 and/or the heterogeneous multi-core processor 170. The execution module 160 may be a module provided by the operating system (or other component) to launch and execute the executable program 150.

In some embodiments, the heterogeneous multi-core processor 170 may be configured with two or more computational units. A “computational unit” may include a general-purpose processor, a special-purpose processor (e.g., a graphics processing unit (GPU)), an application specific integrated circuit (ASIC), or a field-programmable gate array (FPGA), for example. Further, a computational unit may support a specific Instruction Set Architecture (ISA) defining a corresponding set of registers, instructions, and addressing modes. In some embodiments, a computational unit may be referred to as a “core”. For example, the heterogeneous multi-core processor 170 may be configured with a first core 171, a second core 172, and/or additional cores that are not shown in FIG. 1.

In some embodiments, the cores of the heterogeneous multi-core processor 170 may be implemented using one central processing unit (CPU) with multiple accelerators (the communication between the CPU and the multiple accelerators may be achieved through ISA extension), or multiple CPU cores with different processing abilities. Further, the heterogeneous multi-core processor 170 may be configured with cores that support different instruction set architectures (ISAs). For example, the first core 171 (e.g., a MIPS® processor or other processor) may support a first core ISA 137 (e.g., a reduced-instruction set computer (RISC) ISA), and the second core 172 (e.g., an Intel® Pentium® processor or other processor) may support a second core ISA 138 (e.g., a reduced-instruction set computer (RISC) ISA) which is different from the first core ISA 137. The heterogeneous multi-core processor 170 may individually or simultaneously utilize its one or more cores to perform computations and parallel processing.

In some embodiments, the set of source code 110 may include one or more code segments 111, 113, and 115. Each of the code segments 111, 113, and 115 may be deemed a fragment of a program/application's source code, and may include independent and/or isolated programming logic. For example, a code segment may include codes associated with a “function” or “procedure” with predefined inputs and outputs. A code segment may also be a section of code (e.g., a “for” loop) within a function to perform a specific operation, for example. Further, a code segment may be a section of code that can be independently processed by a specific core of the heterogeneous multi-core processor 170, for example. Since each of the first core 171 and the second core 172 may have its unique computational efficiency and power consumption rate, a specific one of the code segments 111, 113, and 115 may be more efficient to be executed by one core than another core of the heterogeneous multi-core processor 170.

In some embodiments, the compiler module 120 may be configured to compile the set of source code 110 into a set of intermediate objects 130. An “intermediate object”, or an “instruction set”, may be a piece of compiled object code having a sequence of instructions in a machine code language or an intermediate language such as register transfer language (RTL). One or more instruction sets may be linked to form an executable file, a library file, or an object file. Thus, the compiler module 120 may compile the code segments 111, 113, and 115 into a corresponding set of instruction sets 131, 133, and 135.

In some embodiments, the compiler module 120 may be configured to compile a code segment into multiple versions of instruction sets each of which is associated with a corresponding ISA. For example, the compiler module 120 may compile the first code segment 111 into two versions of instruction sets: the first instruction set 131 and the first instruction set 132. Each version of the instruction set may be associated with a corresponding ISA, such that this version of the instruction set may be executable by a core of the heterogeneous multi-core processor 170 that supports the corresponding ISA. For example, the instruction set 131 may be executable by the first core 151, and not by the second core 152. As another example, the instruction set 132 may be executable by the second core 152, and not by the first core 151. Thus, the compiler module 120 may compile the code segments 111, 113, and 115 into a first version of instruction sets 131, 133, and 135 that are compatible with the first core ISA 137, and into a second version of instruction sets 132, 134, and 136 that are compatible with the second core ISA 138.

In some embodiments, the core optimization module 140 may be configured to generate the executable program 150 by including and linking one or more intermediate objects 130. The core optimization module 140 may select at least one instruction set to implement each of the code segments in the source code 110, and place the at least one instruction set in the executable program 150. When the specific code segment is associated with multiple versions of instruction sets, the core optimization module 140 may choose one version of the instruction set that, when being processed by its corresponding core, may achieve a higher performance or utilize lower power consumption, for example, than other versions of the instruction sets.

For example, to tailor instruction sets and code segments to specific cores, the core optimization module 140 may choose the instruction set 131 that is associated with the first core ISA 137 to implement the first code segment 111, choose the instruction set 134 that is associated with the second core ISA 138 to implement the second code segment 113, and choose the instruction set 135 that is associated with the first core ISA 137 to implement the third code segment 115. Afterwards, the core optimization module 140 may link these instruction sets and create the executable program 150. In the executable program 150, the instruction set 131 may be the first instruction set 151, the instruction set 134 may be the second instruction set 153, and the instruction set 135 may be the third instruction set 155. Thus, the executable program 150 may be configured with instruction sets that are to be executed by the first core 171 and the second core 172 during run time.

In some embodiments, the execution module 160 may be configured to load the executable program 150 into a memory (not shown in FIG. 1) associated with the heterogeneous multi-core processor 170, and trigger the heterogeneous multi-core processor 170 to execute the instruction sets included in the executable program 150. For example, after loading the instruction sets 151, 153, and 155 into the memory, the execution module 160 may instruct the first core 171 to execute the first instruction set 151. Likewise, the execution module 160 may instruct the second core 172 to execute the second instruction set 153, and instruct the first core 171 to execute the third instruction set 155.

In some embodiments, the core optimization module 140 may link multiple versions of instruction sets that are associated with a single code segment into the same executable program 150. In this case, the execution module 160 may be configured to determine the load and power consumption of the first core 171 and the second core 172 when running the executable program 150, and execute one of the multiple versions of the instruction sets in the executable program 150 that can better utilize the heterogeneous multi-core processor 170. For example, the execution module 160 may identify one of the cores having less utilization or consuming less power, and instruct the identified core to execute the associated version of instruction set. The details of compilation of multiple versions of instruction sets for a heterogeneous multi-core processor are further described below.

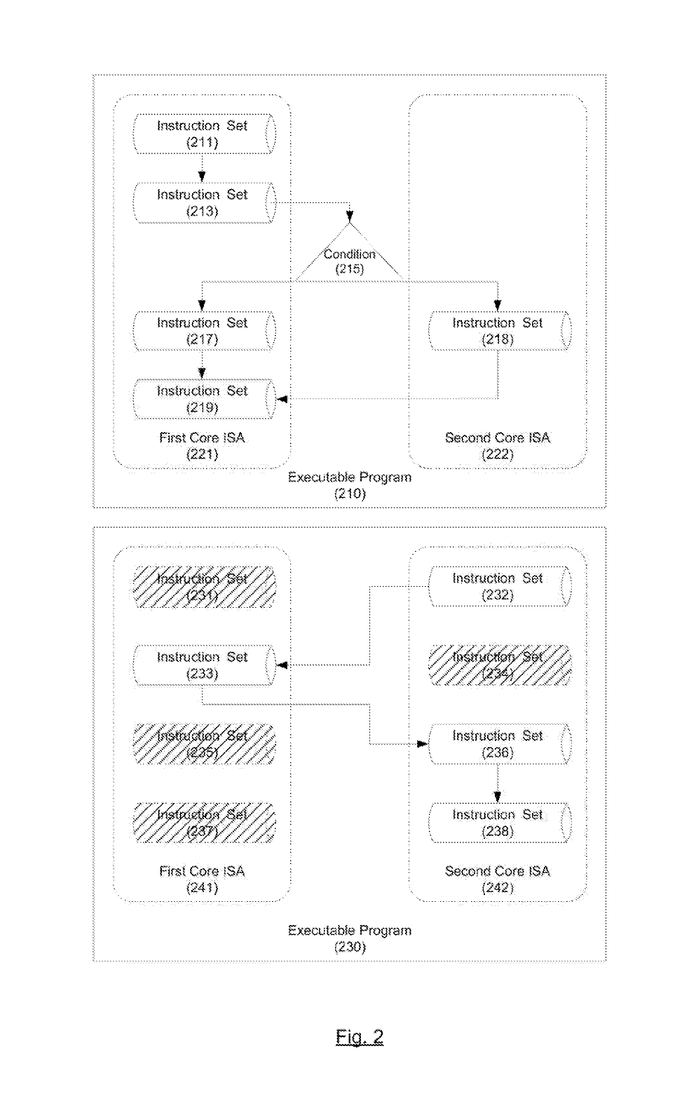

FIG. 2 shows illustrative embodiments of executable programs that are optimized or otherwise tailored when executed by a heterogeneous multi-core processor. In FIG. 2, a multi-core compilation system having a compiler module and a core optimization module (similar to the multi-core compilation system 100, the compiler module 120, and the core optimization module 140 of FIG. 1, not shown in FIG. 2) may compile a set of source code and generate an executable program 210 that is optimized/tailored when executed by a heterogeneous multi-core processor having a first core and a second core (similar to the heterogeneous multi-core processor 170 of FIG. 1, not shown in FIG. 2). The multi-core compilation system may also be configured to generate another optimized/tailored executable program 230 based on a set of intermediate objects (similar to the intermediate objects 130 of FIG. 1) associated with the first core's ISA or the second core's ISA.

In some embodiments, the compiler module (and/or the core optimization module) may determine how to divide the set of source code into multiple code segments, and select a core of the heterogeneous multi-core processor as a default core to execute the executable program to be generated. Specifically, the set of source code may be associated with a specific application, and the compiler module may be configured to analyze and determine the type of the specific application before compiling the set of source code. For example, the compiler module may obtain compiling parameters and/or application parameters (e.g., file extensions and/or application compiling options) from the compiling command and the set of source code to determine the characteristics of the application. Based on the collected parameters, the compiler module may determine that the application may perform a large amount of graphical manipulations. Similarly, the compiler module may identify that the application involves a lot of database operations.

In some embodiments, based on the type and characteristics of the application, the compiler module may identify a core of the heterogeneous multi-core processor that is appropriate for this type of application, and assign this core as a default core to execute the executable program generated based on the set of source code. For example, when the application is graphical-operation-intensive, then a GPU core that is specialized to perform graphical calculations may be the appropriate core. Afterward, the compiler module may divide the set of source code into a set of code segments, each of which may be suitable for execution by the default core. The compiler module may compile each one of the code segments, and generate a corresponding set of instruction sets associated with the default core's ISA. As shown in FIG. 2, the compiler module may identify that the application is more suitable for execution by the first core, and generate a version of instruction sets 211, 213, 217 and 219 that are associated with the first core ISA 221.

In some embodiments, after the compiler module generates a version of instruction sets for a particular core, the core optimization module may evaluate these instruction sets, in order to identify one or more instruction sets that may be less efficient when executed by the particular core. Specifically, the core optimization module may determine a performance indicator associated with a core when executing a specific instruction set. A “performance indicator” of the core may be the core's power consumption, current load, temperature, or other measurements during operation. For example, the higher the power consumption, the current load, or the temperature of the core, the lower the performance of the core. Thus, the core optimization module may optimize (or otherwise improve or increase) the performance of the heterogeneous multi-core processor by finding approaches to lower the core's performance indicators (e.g., power consumption, current load, clock speed, or temperature).

In some embodiments, the core optimization module may evaluate the “power consumption” performance indicator when the core processes the instruction sets included in the executable program. Firstly, the compiler module may acquire a compile-time scheduling chart of the source code, and determine whether one or more of the instruction sets generated based on the source code may be repeatedly scheduled. A “repeatedly-scheduled instruction set” may be an instruction set having an occurrence scheduling count in the compile-time scheduling chart that is above a particular occurrence threshold (e.g., five times). Thus, the repeatedly-scheduled instruction set may be a good candidate for evaluating its power consumption, as any power saving from the repeatedly-scheduled instruction set may reduce the overall power consumption of the heterogeneous multi-core processor. For example, the core optimization module may acquire the scheduling chart of the source code, and identify that instruction set 217 may be a repeatedly-scheduled and a “candidate” instruction set for power consumption optimization.

In some embodiments, the core optimization module may estimate/predict a power consumption value for the default core executing the candidate instruction set 217. Before estimating the power consumption value, the core optimization module may build a linear or non-linear regression model for all the instructions supported by the default core. The linear or non-linear regression model may be used to store power consumption values for each of the supported instructions. Afterward, the core optimization module may identify the instructions in the candidate instruction set 217, extract the stored power consumption values for these instructions from the linear or non-linear regression model, and perform an estimation calculation (e.g., accumulation) based on the extracted power consumption values. The estimated value may then be deemed the performance indicator associated with the default core when executing the candidate instruction set 217.

In some embodiments, rather than estimating/predicting the power consumption value, the core optimization module may measure the power consumption value of the default core executing the candidate instruction set 217 by performing a trial execution of the candidate instruction set 217 using the default core. The core optimization module may then collect the power consumption value associated with the default core trial-executing the candidate instruction set 217. The collected power consumption value, which may be used to build a linear or non-linear regression model for further references, may be deemed the performance indicator associated with the default core when executing the candidate instruction set 217. In some embodiments, the above approaches may be adapted to estimate or measure other performance indicators (e.g., the current load value, clock speed, or temperature value) of the default core when executing the candidate instruction set 217.

In some embodiments, the core optimization module may determine whether the default core is operating efficiently by comparing the performance indicator with a particular threshold. For example, when the performance indicator is a power consumption value, the particular threshold may be a particular power consumption threshold (such as a predetermined threshold) when the default core is under a medium (e.g. 50%) load. When the performance indicator is a temperature value, the particular threshold may also be a particular temperature threshold (e.g., 40 degrees). Upon a determination that the performance indicator is below the particular threshold, the core optimization module may determine that the default core may be operating efficiently, and may continue using the candidate instruction set 217 in the executable program 210. If the performance indicator is equal or above the particular threshold, the core optimization module may interpret that the default core may be less efficient in executing the candidate instruction set 217. In this case, the core optimization module may evaluate whether to utilize an alternative core of the heterogeneous multi-core processor to execute the instruction set corresponding to the code segment.

In some embodiments, the core optimization module may identify the specific code segment that is associated with the candidate instruction set 217, and the compiler module may compile the specific code segment to generate another version of instruction set 218 associated with the alternative core (e.g., the second core). In other words, either the instruction set 217 or the instruction set 218 may implement the specific code segment in the executable program 210. Afterward, the core optimization module may include the instruction set 217 and the instruction set 218 in the executable program 210, so that during run time, the heterogeneous multi-core processor may utilize either its first core to execute the instruction set 217, or its second core to execute to instruction set 218.

In some embodiments, the core optimization module may determine whether the default core is operating efficiently by comparing the default core's performance indicator with an alternative core's performance indicator. Specifically, the core optimization module may generate the instruction set 218 as described above, and estimate or measure the alternative core's performance indicator similar to the estimating or measuring the default core's performance indicator. If the default core's performance indicator is below the alternative core's performance indicator, the core optimization module may determine that the default core may be operating efficiently, and may continue using the candidate instruction set 217 in the executable program 210. If the default core's performance indicator is equal or above the alternative core's performance indicator, the core optimization module may interpret that the default core may be less efficient in executing the candidate instruction set 217. In this case, the core optimization module may include the instruction set 217 and the instruction set 218 in the executable program 210, as described above.

In some embodiments, the core optimization module may generate and link a conditional instruction set 215 into the executable program 210, in order to select either the instruction set 217 or the instruction set 218 to execute during run time. Specifically, the “conditional instruction set” 215 may include instructions to measure the performance indicator of the default core executing the instruction set 217 and/or the performance indicator of the alternative core executing the instruction set 218. Assuming the original order of execution for all the instructions sets associated with the first core ISA 221 is instruction set 211, instruction set 213, instruction set 217, and instruction set 219, the instruction set 217 may be executed after the complete executing of the instruction set 213. In this case, the core optimization module may direct the instruction set 213 to “jump” to the condition instruction set 215, and depending on the outcome of the execution of the condition instruction set 215, either execute the instruction set 217 or the instruction set 218 afterward. Further, the core optimization module may execute the instruction set 219 after the completion of either the instruction set 217 or the instruction set 218.

In some embodiments, during a first round of execution, the execution module may execute the condition instruction set 215, which may direct the execution module to using the first core to execute the instruction set 217. In the meantime, the execution module may measure/collect the performance indicator of the first core executing the instruction set 217. For example, the execution module may measure the power consumption, current load, and temperature of the first core during the first core's execution of the instruction set 217. Afterward, the execution module may store the measured performance indicator for subsequent rounds of execution.

In some embodiments, during a second round of execution subsequent to the first round, the execution module may execute the condition instruction set 215 again, which may retrieve the stored performance indicator measured from the first round of execution. If the execution module determines that the retrieved first round's performance indicator is equal or above a particular threshold, then the execution module may load the instruction set 218 instead of the instruction set 217, and instruct the second core to execution the instruction set 218. If the retrieved first round's performance indicator is below the particular threshold, the execution module may execute the instruction set 217 and collect performance indicator, as described above in the first round of execution. During the execution of the instruction set 218, the execution module may measure/collect the performance indicator of the second core executing the instruction set 218, and store the measured performance indicator for subsequent rounds of execution.

In some embodiments, during a subsequent round of execution, the execution module may execute the condition instruction set 215, which may retrieve the stored second core's performance indicator measured from the previous round of execution. If the execution module determines that the retrieved previous round second core's performance indicator is equal or above an earlier round first core's performance indicator, then the execution module may switch back to the execution of the instruction set 217 by the first core. If the retrieved previous round second core's performance indicator is below the earlier round first core's performance indicator, the execution module may continue executing the instruction set 218 using the second core and collect second core's performance indicator, as described above. Thus, the execution module may be configured to choose which core and its associated instruction set to execute during run time, based on the performance indicators of the first core or the second core during previous rounds of execution. Such an approach may lead to an overall higher efficiency in utilizing the heterogeneous multi-core processor to execute the executable program 210.

In some embodiments, in addition to/in lieu of optimizing or otherwise tailoring the executable program 210 during run time, a code optimization module may optimize/tailor the executable program 230 during compilation and linking stages. Afterward, the executable program 230 may be executed by the multiple cores of the heterogeneous multi-core processor. Specifically, the compiler module may analyze the source code and generate multiple versions of the instruction sets, and the code optimization module may identify and link those versions of instruction sets that have better performance into the executable program 230.

In some embodiments, the compiler module may first analyze an application's source code to generate a call graph for the functions in the source code. For example, the compiler module may utilize a compilation tool (e.g., gprof) to generate the call graph. Afterward, the compiler module may perform a profiling analysis to identify one or more hot paths in the call graph that are frequently executed. Specifically, the compiler module may identify a set of inputs that are representative of the typical data that may be used for the application, and utilize the set of inputs to identify a set of hot paths (e.g., 5 hot paths). Each “hot path”, which may include a sequence of various function blocks, may have an execution frequency during the execution that is above a particular frequency threshold (e.g., 3 times). The compiler module may then divide the source code into multiple code segments, each code segments being one of the function blocks identified in the hot paths.

In some embodiments, the compiler module may further perform an instrumentation analysis on the function blocks (or code segments) in the hot paths. Specifically, for a specific core of the heterogeneous multi-core processor, the compiler module may acquire the specific core's trial-execution time for each function block, as well as the performance indicators (e.g., core usage ratio, times of access, power consumption, current load, temperature, etc.) and statistical information collected during the trial-execution. Based on the collected performance indicators and statistical information associated with the specific core, the core optimization module may build a linear or non-linear regression model adopted to estimate the performance of a specific core executing each function block. For each hot path, the core optimization module may perform the above analysis for each core of the heterogeneous multi-core processor.

In some embodiments, the compiler module may compile the code segments in the source code, and generate multiple versions of instruction sets corresponding to the multiple cores supporting multiple ISAs. In other words, for each core associated with a corresponding ISA, the compiler module may generate a specific version of instruction sets for the core's ISA based on the code segments. Afterward, the core optimization module may link the more efficient versions of the instruction sets into the execution program 230.

For example, the compiler module may generate a call graph for an application, and identify one hot path having at least four function blocks. The compiler module may then divide the application's source code into four code segments, each of which includes a corresponding one of the four function blocks. The compiler module (or the core optimization module) may then perform the instrumentation analysis by trial-executing the four function blocks using the first core of the heterogeneous multi-core processor. During the instrumentation analysis, the compiler module may collect the first core's statistical information (e.g., first core's clock speed, times of access) as well as the performance indicators (e.g., power consumption, use ratio of the first core, temperature, energy delay product) associated with the executing of each of the four function blocks. Afterward, the compiler module may utilize the collected statistical information and performance indicators to generate a “first core linear or non-linear performance model” which may be used to estimate the performance of the first core when executing the four function blocks during run time. Further, the compiler module may generate a version of instruction sets (instruction sets 231, 233, 235, and 237) associated with the first core's ISA 241 based on the four function blocks.

Similar to the above process, the compiler module may perform the instrumentation analysis by trial-executing the four function blocks using the second core of the heterogeneous multi-core processor. During the instrumentation analysis, the compiler module may collect the second core's statistical information and the performance indicators associated with executing each of the four function blocks using the second core. Afterward, the compiler module may utilize the collected statistical information and performance indicators to generate a “second core linear or non-linear performance model” which may be used to estimate the performance of the second core when executing the four function blocks. Further, the compiler module may generate a second version of instruction sets (instruction sets 232, 234, 236, and 238) associated with the second core's ISA 242 based on the four function blocks.

In some embodiments, for each function block in each hot path, the core optimization module may use a “greedy method” to select a specific version of the instruction set as well its corresponding core to implement the function block in the executable program 230. For example, the instruction set 231 in the first core ISA 241 and the instruction set 232 in the second core ISA 242 may be associated with the same function block. The core optimization module may retrieve the instruction set 231's statistical information and the performance indicators from the first core linear or non-linear performance model, and the instruction set 232's statistical information and the performance indicators from the second core linear or non-linear performance model. Afterward, the core optimization module may compare the instruction set 231's performance indicators with the instruction set 232's performance indicators. In response to a determination that the instruction set 231's performance indicators are equal or above the instruction set 232's respective counterparts, the core optimization module may select the instruction set 232 to implement the function block in the executable program 230.

In some embodiments, the core optimization module may utilize the greedy method described above to select a specific version of instruction set to implement each function block in the executable program 230. For example, the core optimization module may choose instruction set 233 over the instruction set 234, the instruction set 236 over the instruction set 235, and the instruction set 238 over the instruction set 237. Thus, the core optimization module may include and link the instruction set 232, the instruction set 233, the instruction set 236, and the instruction set 238 to implement the application in the executable program 230. Please note in FIG. 2, the instruction sets that are chosen to be linked into the final executable program 230 are marked with solid lines, and the instruction sets that are not chosen to be linked are marked with dotted line and filled with shadow lines.

In some embodiments, the core optimization module may take the costs associated with the switching from executing using the first core to using the second core (e.g., calling context switching and mapping) into consideration when selecting a particular version of the instruction set to implement a specific function block. Further, the core optimization module may utilize a broad evaluation approach by determining a combination of instruction sets from multiple cores that may achieve a better overall performance (e.g., the lowest power consumption) for the heterogeneous multi-core processor. Under the greedy method, the core optimization module may focus on a specific function block when evaluating and choosing the multiple versions of instruction sets, without taking into consideration the other function blocks in the hot path. Under the broad evaluation approach, the core optimization module may select two or more function blocks for evaluation.

For example, the core optimization module may identify that four pairings of instruction sets (instruction sets 231 and 233, instruction sets 231 and 234, instruction sets 232 and 233, & instruction sets 232 and 234) are associated with two function blocks in a hot path. The core optimization module may then determine the performance indicator for each of the four pairings of instruction sets. Specifically, the core optimization module may estimate/measure the corresponding performance indicators for the instruction sets 231, 232, 233, and 234, and combine these performance indicators to generate the performance indicator for the pairing of instruction sets. Afterward, the core optimization module may select one pairing of instruction sets for having the best combined/overall performance indicators among these four pairings, after taking each pairing's strengths and weaknesses into consideration. Thus, the selected one pairing of instruction sets may achieve the best performance objectives (e.g., least power consumption, best performance throughput, etc) when being linked into the final executable program 230 and scheduled/executed by the heterogeneous multi-core processor 210.

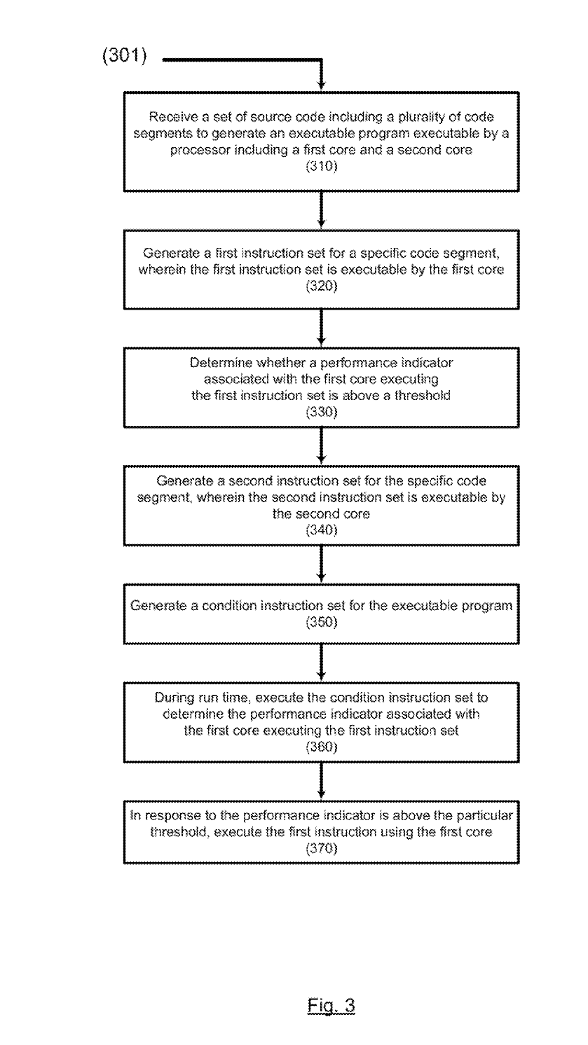

FIG. 3 shows a flow diagram of an illustrative embodiment of a process to compile multiple versions of instruction sets that may be used in connection with a heterogeneous multi-core processor during run time. The process 301 may include one or more operations, functions, or actions as illustrated by blocks 310, 320, 330, 340, 350, 360, and 370, which may be performed by hardware, software and/or firmware. The various blocks are not intended to be limiting to the described embodiments. For example, for this and other processes and methods disclosed herein, the operations performed in the processes and methods may be implemented in differing order.

Furthermore, the outlined operations in FIG. 3 and/or otherwise shown and described elsewhere herein are provided as examples, and some of the operations may be optional, combined into fewer operations, supplemented with other operations, or expanded into additional operations without detracting from the essence of the disclosed embodiments. Although the blocks are illustrated in a sequential order, these blocks may also be performed in parallel, and/or in a different order than those described herein. In some embodiments, machine-executable instructions for the process 301 or other process(es) described herein may be stored in memory or other tangible non-transitory computer-readable storage medium, executed by a processor, and/or implemented in a multi-core compilation system.

At block 310 (“Receive a set of source code including a plurality of code segments to generate an executable program executable by a processor including a first core and a second core”), a multi-core compilation system may receive a set of source code including a plurality of code segments. The multi-core compilation system may be configured to compile the set of source code and generate an executable program that is executable by a heterogeneous multi-core processor including a first core and a second core.

At block 320 (“Generate a first instruction set for a specific code segment, wherein the first instruction set is executable by the first core”), the multi-core compilation system may generate a first instruction set based on a specific code segment selected from the plurality of code segments. The generated first instruction set may be executable by the first core of the heterogeneous multi-core processor. Specifically, a compiler module of the multi-core compilation system may generate a scheduling chart for the plurality of code segments. Afterward, the compiler module may identify the specific code segment in the plurality of code segments as having an occurrence count in the scheduling chart that is above a particular occurrence threshold.

At block 330 (“Determine whether a performance indicator associated with the first core executing the first instruction set is above a thread”), a core optimization module of the multi-core compilation system may estimate/measure a performance indicator associated with the first core executing the first instruction set, and determine whether the performance indicator is above a particular threshold.

At block 340 (“Generate a second instruction set for the specific code segment, wherein the second instruction set is executable by the second core”), the core optimization module of the multi-core compilation system may generate a second instruction set for the specific code segment. The second instruction set may be executable by the second core of the heterogeneous multi-core processor. Further, the first instruction set supports the first core's instruction set architecture (ISA), and the second instruction set supports the second core's ISA. The core optimization module may link the first instruction set and the second instruction set into the executable program.

At block 350 (“Generate a condition instruction set for the execution program”), the core optimization module of the multi-core compilation system may generate a condition instruction set for the executable program. The condition instruction set may be configured to determine the performance indicator associated with the first core executing the first instruction set during execution of the executable program. The core optimization module may link the condition instruction set with the first instruction set and the second instruction set in the executable program.

At block 360 (“During run time, execute the condition instruction set to determine the performance indicator associated with the first core executing the first instruction set”), during execution of the executable program, the execution module of the multi-core compilation system may execute the condition instruction set to determine the performance indicator associated with the first core executing the first instruction set. In some embodiments, the condition instruction set may collect a power consumption value of the first core as the performance indicator associated with the first core. The condition instruction set may also collect a load value of the first core as the performance indicator associated with the first core. Further, the condition instruction set may collect a temperature value of the first core as the performance indicator associated with the first core.

At block 370 (“In response to the performance indicator is above the particular threshold, execute the first instruction set using the first core”), during execution of the executable program, in response to a determination that the performance indicator associated with the first core is below the particular threshold, the execution module may execute the first instruction set using the first core. In response to the determination that the performance indicator associated with the first core is above the particular threshold, the execution module may execute the second instruction set using the second core.

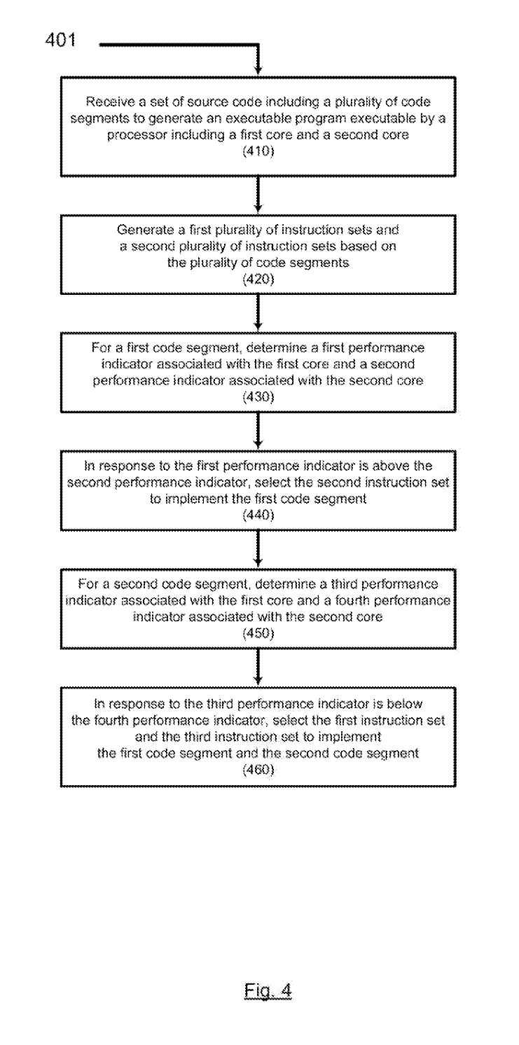

FIG. 4 shows a flow diagram of an illustrative embodiment of a process to compile multiple versions of instruction sets for a heterogeneous multi-core processor during compilation time. The process 401 may include one or more operations, functions, or actions as illustrated by blocks 410, 420, 430, 440, 450, 460, and 470, which may be performed by hardware, software and/or firmware. The various blocks are not intended to be limiting to the described embodiments. For example, for this and other processes and methods disclosed herein, the operations performed in the processes and methods may be implemented in differing order.

At block 410 (“Receive a set of source code including a plurality of code segments to generate an executable program executable by a processor including a first core and a second core”), a multi-core compilation system may receive a set of source code including a plurality of code segments. The multi-core compilation system may be configured to compile the set of source code into an executable program that is executable by the heterogeneous multi-core processor that includes a first core and a second core.

At block 420 (“Generate a first plurality of instruction sets and a second plurality of instruction sets based on the plurality of code segments”), the multi-core compilation system may generate a first plurality of instruction sets based on the plurality of code segments. The first plurality of instruction sets may be executable by the first core of the heterogeneous multi-core processor. Further, the multi-core compilation system may generate a second plurality of instruction sets based on the plurality of code segments. The second plurality of instruction sets may be executable by the second core of the heterogeneous multi-core processor.

At block 430 (“for a first code segment, determine a first performance indicator associated with the first core and a second performance indicator associated with the second core”), for a first code segment selected from the plurality of code segments and associated with a first instruction set of the first plurality of instruction sets and a second instruct set of the second plurality of instruction sets, the multi-core compilation system may determine a first performance indicator associated with the first core executing the first instruction set and a second performance indicator associated with the second core executing the second instruction set.

In some embodiments, the multi-core compilation system may determine an execution path having a set of code segments selected from the plurality of code segments. The execution path may have an execution frequency in the set of source code that is above a particular frequency threshold. The multi-core compilation system may then select the above first code segment from the set of code segments.

In some embodiments, the multi-core compilation system may simulate the first core executing the first instruction set and the second core executing the second instruction set. Afterward, the multi-core compilation system may construct a regression model based on the statistical information and performance indicators collected during the above simulation processes. Further, the multi-core compilation system may determine the first performance indicator and the second performance indicator by estimating the first performance indicator and the second performance indicator based on the regression model.

At block 440 (“in response to the first performance indicator is above the second performance indicator, select the second instruction set to implement the first code segment”), in response to a determination that the first performance indicator is above the second performance indicator, the multi-core compilation system may select the second instruction set to implement the first code segment in the executable program. In response to the determination that the first performance indicator is below the second performance indicator, the multi-core compilation system may select the first instruction set to implement the first code segment in the executable program.

At block 450 (“For a second code segment, determine a third performance indicator associated with the first core and a fourth performance indicator associated with the second core”), for a second code segment selected from the plurality of code segments and associated with a third instruction set of the first plurality of instruction sets and a fourth instruction set of the second plurality of instruction sets, the multi-core compilation system may determine a third performance indicator associated with the first core executing the first instruction set and the third instruction set and a fourth performance indicator associated with the second core executing the second instruction set and the fourth instruction set.

At block 460 (“in response to the third performance indicator is below the fourth performance indicator, select the first instruction set and the third instruction set to implement the first code segment and the second code segment”), in response to a determination that the third performance indicator is below the fourth performance indicator, the multi-core compilation system may select the first instruction set and the third instruction set to implement the first code segment and the second code segment in the executable program. In response to the determination that the third performance indicator is above the fourth performance indicator, the multi-core compilation system may select the second instruction set and the fourth instruction set to implement the first code segment and the second code segment in the executable program.

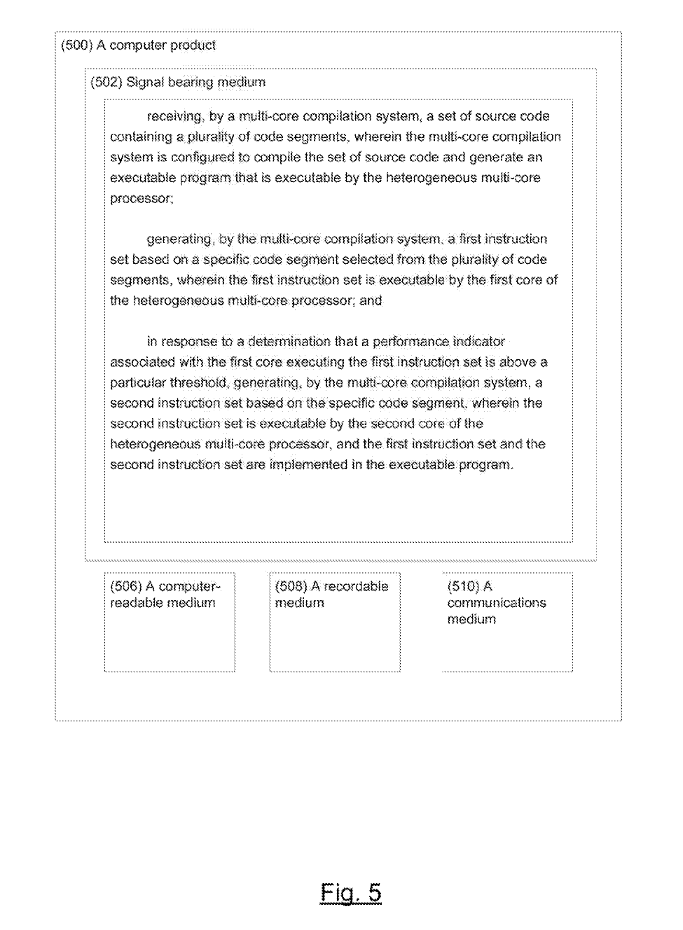

FIG. 5 is a block diagram of an illustrative embodiment of a computer program product 500 to implement a method to update data stored in a storage block. Computer program product 500 may include a signal bearing medium 502. Signal bearing medium 502 may include one or more sets of executable instructions 504 stored thereon that, in response to execution by, for example, a processor, may provide the features and operations described above. Thus, for example, referring to FIG. 1, the multi-core compilation system may undertake one or more of the operations shown in at least FIG. 3 in response to the instructions 504.

In some implementations, signal bearing medium 502 may encompass a non-transitory computer readable medium 506, such as, but not limited to, a hard disk drive, a Compact Disc (CD), a Digital Versatile Disk (DVD), a digital tape, memory, etc. In some implementations, signal bearing medium 502 may encompass a recordable medium 508, such as, but not limited to, memory, read/write (R/W) CDs, R/W DVDs, etc. In some implementations, signal bearing medium 502 may encompass a communications medium 510, such as, but not limited to, a digital and/or an analog communication medium (e.g., a fiber optic cable, a waveguide, a wired communications link, a wireless communication link, etc.). Thus, for example, referring to FIG. 1, computer program product 500 may be wirelessly conveyed to the multi-core compilation system 100 by signal bearing medium 502, where signal bearing medium 502 is conveyed by communications medium 510 (e.g., a wireless communications medium conforming with the IEEE 802.11 standard). Computer program product 500 may be recorded on non-transitory computer readable medium 506 or another similar recordable medium 508.

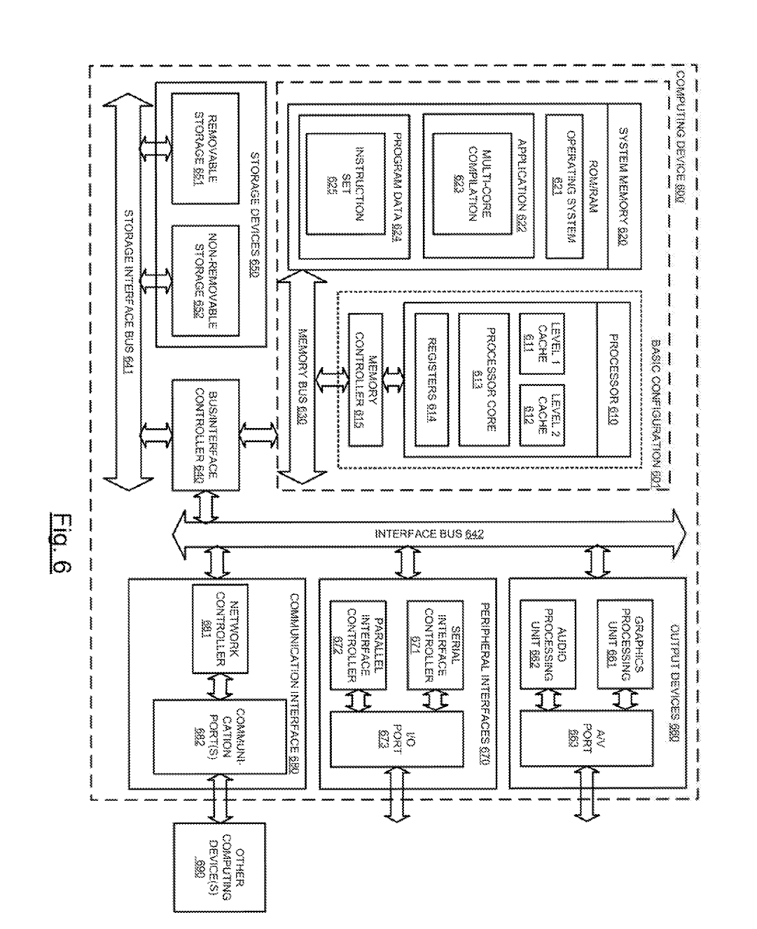

FIG. 6 shows a block diagram of an illustrative embodiment of an example computer system 600. In a very basic configuration 601, the computer system 600 may include one or more processors 610 and a system memory 620. A memory bus 630 may be used to communicate between the processor 610 and the system memory 620.

Depending on the desired configuration, processor 610 may be of any type including but not limited to a microprocessor (μP), a microcontroller (μC), a digital signal processor (DSP), or any combination thereof. Processor 610 can include one or more levels of caching, such as a level one cache 611 and a level two cache 612, a processor core 613, and registers 614. The processor core 613 can include an arithmetic logic unit (ALU), a floating point unit (FPU), a digital signal processing core (DSP Core), or any combination thereof. In one embodiment, the heterogeneous multi-core processor 170 (such as shown in FIG. 1) may be implemented by the processor 610. The cores 171, 172, etc of the heterogeneous multi-core processor 170 (such as shown in FIG. 1) may each be implemented by individual ones of a plurality of the processor core 613. A memory controller 615 can also be used with the processor 610, or in some implementations the memory controller 615 can be an internal part of the processor 610.

Depending on the desired configuration, the system memory 620 may be of any type including but not limited to volatile memory (such as RAM), non-volatile memory (such as ROM, flash memory, etc.) or any combination thereof. The system memory 620 may include an operating system 621, one or more applications 622, and program data 624. The application 622 may include a multi-core compilation application 623 that is arranged to perform the operations as described herein including at least the operations described with respect to the process 301 of FIG. 3 and/or described elsewhere in this disclosure. The program data 624 may include instruction sets 625 to be accessed by the multi-core compilation application 623, and/or may include other objects, code, data, instructions, etc. as described herein. In some embodiments, the compiler module 120 of FIG. 1 may be implemented as the application 622 to operate with the program data 624 on the operating system 621. Specifically, the compiler module 120 may generate the instruction set 625 based on a set of source code. This described basic configuration is illustrated in FIG. 6 by those components within dashed line 601.

Computing device 600 may have additional features or functionality, and additional interfaces to facilitate communications between basic configuration 601 and any required devices and interfaces. For example, a bus/interface controller 640 may be used to facilitate communications between basic configuration 601 and one or more data storage devices 650 via a storage interface bus 641. Data storage devices 650 may be removable storage devices 651, non-removable storage devices 652, or a combination thereof. Examples of removable storage and non-removable storage devices include magnetic disk devices such as flexible disk drives and hard-disk drives (HDDs), optical disk drives such as compact disk (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer readable instructions, data structures, program modules, or other data.

System memory 620, removable storage devices 651, and non-removable storage devices 652 are examples of computer storage media. Computer storage media includes, but is not limited to, RAM, ROM, EEPROM, flash memory or other memory technology, CD-ROM, digital versatile disks (DVDs) or other optical storage, magnetic cassettes, magnetic tape, magnetic disk storage or other magnetic storage devices, or any other medium which may be used to store the desired information and which may be accessed by computing device 600. Any such computer storage media may be part of computing device 600.

Computing device 600 may also include an interface bus 642 to facilitate communication from various interface devices (e.g., output devices 660, peripheral interfaces 670, and communication devices 680) to basic configuration 601 via bus/interface controller 640. Example output devices 660 include a graphics processing unit 661 and an audio processing unit 662, which may be configured to communicate to various external devices such as a display or speakers via one or more AN ports 663. Example peripheral interfaces 670 include a serial interface controller 671 or a parallel interface controller 672, which may be configured to communicate with external devices such as input devices (e.g., keyboard, mouse, pen, voice input device, touch input device, etc.) or other peripheral devices (e.g., printer, scanner, etc.) via one or more I/O ports 673. An example communication device 680 includes a network controller 681, which may be arranged to facilitate communications with one or more other computing devices 690 over a network communication link via one or more communication ports 682. In some implementations, computing device 600 includes a multi-core processor, which may communicate with the host processor 610 through the interface bus 642.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 600 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 600 may also be implemented as a personal computer including both laptop computer and non-laptop computer configurations.

The use of hardware or software may be generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, each function and/or operation within such block diagrams, flowcharts, or examples can be implemented, individually and/or collectively, by a wide range of hardware, software, firmware, or virtually any combination thereof. In some embodiments, several portions of the subject matter described herein may be implemented via Application Specific Integrated Circuits (ASICs), Field Programmable Gate Arrays (FPGAs), digital signal processors (DSPs), or other integrated formats. However, some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware are possible in light of this disclosure. In addition, the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to”, etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, various embodiments of the present disclosure have been described herein for purposes of illustration, and various modifications may be made without departing from the scope and spirit of the present disclosure. Accordingly, the various embodiments disclosed herein are not intended to be limiting, with the true scope and spirit being indicated by the following claims.

1. A method to compile code for a heterogeneous multi-core processor that includes a first core and a second core, the method comprising:
receiving, by a multi-core compilation system, a set of source code that includes a plurality of code segments, wherein the multi-core compilation system is configured to compile the set of source code and generate an executable program that is executable by the heterogeneous multi-core processor;
generating, by the multi-core compilation system, a first instruction set based on a specific code segment selected from the plurality of code segments, wherein the first instruction set is executable by the first core of the heterogeneous multi-core processor; and
in response to a determination that a performance indicator associated with the first core executing the first instruction set is above a particular threshold, generating, by the multi-core compilation system, a second instruction set based on the specific code segment, wherein the second instruction set is executable by the second core of the heterogeneous multi-core processor, and the first instruction set and the second instruction set are implemented in the executable program.

2. The method of claim 1, further comprising:
generating, by the multi-core compilation system, a condition instruction set for the executable program, wherein the condition instruction set is configured to determine the performance indicator associated with the first core executing the first instruction set during execution of the executable program.

3. The method of claim 2, further comprising:
during execution of the executable program, executing, by the multi-core compilation system, the condition instruction set to determine the performance indicator for the first core executing the first instruction set; and
in response to a determination that the performance indicator associated with the first core is below the particular threshold, executing, by the multi-core compilation system, the first instruction set using the first core.

4. The method of claim 3, further comprising:
in response to the determination that the performance indicator associated with the first core is above the particular threshold, executing, by the multi-core compilation system, the second instruction set using the second core.

5. The method of claim 1, further comprising:
generating a scheduling chart for the plurality of code segments; and
identifying the specific code segment in the plurality of code segments as having an occurrence count in the scheduling chat that is above a particular occurrence threshold.

6. The method of claim 1, wherein the determination of the performance indicator comprises:
collecting a power consumption value of the first core as the performance indicator associated with the first core during execution of the first instruction set.

7. The method of claim 1, wherein the determination of the performance indicator comprises:
collecting a temperature value of the first core as the performance indicator associated with the first core during execution of the first instruction set.

8. A method to compile code for a heterogeneous multi-core processor that includes a first core and a second core, the method comprising:
receiving, by a multi-core compilation system, a set of source code that includes a plurality of code segments, wherein the multi-core compilation system is configured to compile the set of source code into an executable program that is executable by the heterogeneous multi-core processor;
generating, by the multi-core compilation system based on the plurality of code segments, a first plurality of instruction sets that are executable by the first core of the heterogeneous multi-core processor;
generating, by the multi-core compilation system based on the plurality of code segments, a second plurality of instruction sets that are executable by the second core of the heterogeneous multi-core processor;
for a first code segment selected from the plurality of code segments and associated with a first instruction set of the first plurality of instruction sets and a second instruct set of the second plurality of instruction sets, determining, by the multi-core compilation system, a first performance indicator associated with the first core executing the first instruction set and a second performance indicator associated with the second core executing the second instruction set; and
in response to a determination that the first performance indicator is above the second performance indicator, selecting, by the multi-core compilation system, the second instruction set to implement the first code segment in the executable program.

9. The method of claim 8, wherein the determining the first performance indicator and the second performance indicator comprises:
constructing a regression model by simulating the first core executing the first instruction set; and
estimating the first performance indicator associated with the first core based on the regression model and the first instruction set.

10. The method of claim 8, further comprising:
determining an execution path having a set of code segments selected from the plurality of code segments, wherein the execution path has an execution frequency in the set of source code that is above a particular frequency threshold; and
selecting the first code segment from the set of code segments.

11. The method of claim 8, further comprising:
for a second code segment selected from the plurality of code segments and associated with a third instruction set of the first plurality of instruction sets and a fourth instruction set of the second plurality of instruction sets, determining a third performance indicator associated with the first core executing the first instruction set and the third instruction set and a fourth performance indicator associated with the second core executing the second instruction set and the fourth instruction set; and
in response to a determination that the third performance indicator is below the fourth performance indicator, selecting the first instruction set and the third instruction set to implement the first code segment and the second code segment in the executable program.

12. A multi-core compilation system to compile code for a heterogeneous multi-core processor that includes a first core and a second core, the system comprising:
a compiler module configured to:
receive a set of source code that includes a plurality of code segments,
generate a first instruction set for a first code segment selected from the plurality of code segments, wherein the first instruction set is executable by the first core, and
generate a second instruction set for the first code segment, wherein the second instruction set is executable by the second core; and
a code optimization module coupled with the compiler module, wherein the code optimization module is configured to:
link the first instruction set and the second instruction set into an executable program that is executable by the heterogeneous multi-core processor.

13. The system as recited in claim 12, further comprising:
an execution module coupled with the code optimization module to execute the executable program, wherein the execution module is configured to:
determine a performance indicator associated with the first core executing the first instruction set, and
in response to the determination that the performance indicator is above a particular threshold, execute the second instruction set using the second core.

14. The system as recited in claim 13, wherein the execution module is further configured to:
in response to the determination that the performance indicator is below the particular threshold, execute the first instruction set using the first core.

15. The system as recited in claim 13, wherein the compiler module is further configured to generate a condition instruction set, and the code optimization module is further configured to link the condition instruction set with the first instruction set and the second instruction set in the executable program.

16. The system as recited in claim 15, wherein the execution module is further configured to execute the condition instruction set to determine whether the performance indicator is above the particular threshold during execution of the executable program.

17. The system as recited in claim 12, wherein the first instruction set supports the first core's instruction set architecture (ISA), and the second instruction set supports the second core's ISA.

18. The system as recited in claim 12, wherein the code optimization module is further configured to:
determine a first performance indicator associated with the first core executing the first instruction set, a second performance indicator associated with the second core executing the second instruction set, and
in response to a determination that the first performance indicator is above the second performance indicator, select the second instruction set to implement the first code segment in the execution program.

19. The system as recited in claim 18, wherein:
the compiler module is further configured to:
for a second code segment selected from the plurality of code segments, generate a third instruction set executable by the first core and a fourth instruct set executable by the second core, and
the code optimization module is further configured to
determine a third performance indicator associated with the first core executing the third instruction set, and a fourth performance indicator associated with the second core executing the fourth instruction set, and
in response to a determination that the third performance indicator is below the fourth performance indicator, select the third instruction set to implement the second code segment in the executable program.

20. The system as recited in claim 19, wherein the code optimization module is further configured to link the second instruction set and the third instruction set into the executable program.

21-22. (canceled)
